(19) United States
(12) Patent Application Publication
(10) Pub. No.: US 2007/0133494 A1
(43) Pub. Date: Jun. 14, 2007

(54) Method and computer readable media for efficient channel access by using partial error detection code in centralized wireless communication system

(76) Inventors: Hung-Chun Lai, Hsin-Chuang (TW); Heng-Iang Hsu, Taipei (TW); Chih-Chiang Hsieh, Kaohsiung County (TW); Shiann-Tsong Sheu, Taipei (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/360,159

(22) Filed: Feb. 23, 2006

(30) Foreign Application Priority Data
Dec. 13, 2005 (TW) 094144109

(51) Int. Cl. H04B 7/216

(52) U.S. Cl. 370/342

(57) ABSTRACT

A method for efficient channel access by using partial error detection code is utilized in a centralized wireless communication system. The partial error detection code is derived from the error detection codes of the transport layer to act as the reference of the error detection of a protocol data unit. This method performs a data validation test in a data-link layer. If an error is found, the proceeding data transmission will be stopped immediately to avoid unnecessary waste of the bandwidth resource of a web channel.

### CROSS-REFERENCES TO RELATED APPLICATIONS

This application claims priority to Taiwan Patent Application No. 094144109 filed on Dec. 13, 2005.

### BACKGROUND OF THE INVENTION

1. Field of the Invention

The present invention relates to a method for network transmission and a computer program product therefor; specifically to a method for assigning bandwidth of network channels efficiently and a computer program product therefor.

2. Descriptions of the Related Art

Due to the rapid development of technologies of network transmission and communication, daily life of modem people depends on networks greatly from day to day. How to transmit data efficiently and correctly in a wireless communication system is still being paid much attention. The Open System Interface (OSI) established by the Institute of Electrical and Electronic Engineers (IEEE) defines standards for communication medium access, speed, cable format, and network connection methods. In addition, the transport layer of the OSI seven-layer model also provides a reliable transmission service, which defines protocols for controlling package sequence, data flow, error detection, and error recovery.

Nevertheless, bandwidth is not utilized efficiently by the aforementioned data transmission and error detection mechanism. We use the following example to elaborate the concept. In FIG. 1 is a centralized wireless communication system, which comprises a Base Station (BS) 10 and a plurality of Subscriber Stations (SS) 20. The base station 10 is used to transmit and receive data of subscriber stations in the system and is in charge of assigning channel bandwidths. When the base station is a transmitter and utilizes time slots of Time Division Multiple Access (TDMA), the transmitter uses a Media Access Control (MAC) layer of the data link layer, divides the Service Data Unit (SDU) comprising an error detection code inside into a plurality of Protocol Data Units (PDUs), and then transmits the PDUs via the reserved time slots sequentially. After the receiver receives the PDUs, it assembles PDUs from the same SDU and then transmits them to the upper layer, i.e., transport layer, for error detection. The SDU is accepted if there is no error; otherwise, the SDU is discarded.

By doing so, in a centralized wireless communication system an error can only be detected after the receiver receives and assembles all the data. Meantime, the base station has to provide bandwidth for subscriber stations continuously. Not until all the data are received and assembled can they be provided to the transport layer to make a determination. If the received data is determined to be an erroneous one after error detection, the precedent provided bandwidth is wasted. This degrades the efficiency of the channel bandwidths.

According to the aforementioned description, how to increase the utilization of the bandwidth of a wireless communication system under the condition of correct transmission is still a key research issue. Consequently, in order to improve the utilization of network resource, a detection method for detecting the correctness of network package transmission is in great demand.

### SUMMARY OF THE INVENTION

An object of this invention is to provide a detection method for detecting the correctness of network package transmission. The method is utilized in a centralized wireless communication system which comprises at least a transmitter and a receiver. The transmitter transmits data to the receiver through a channel. The data comprises a Service Data Unit (SDU). The detection method comprises the following steps of:

(a) dividing the SDU into a plurality of Protocol Data Units (PDUs) by the transmitter;

(b) calculating an error detection relation equation for each of the PDUs respectively and storing a first checking bit in a header of the PDUs by the transmitter;

(c) transmitting the PDUs to the receiver by the transmitter;

(d) receiving the PDUs sequentially and calculating a second checking bit of each of the PDUs respectively according to the error detection relation equation by the receiver;

(e) comparing the first checking bit in the header of each of the PDUs with the second checking bit by the receiver; and

(f) transmitting a message to the transmitter to stop the transmitter from transmitting the PDUs to the receiver by the receiver, when the first checking bit does not conform to the second checking bit.

Another object of this invention is to provide a computer program product for storing a computer program to execute a detection method for detecting the correctness of network package transmission. The method is utilized in a centralized wireless communication system which comprises at least a transmitter and a receiver, the transmitter transmitting data to the receiver through a channel, the data comprising a Service Data Unit SDU. The detection method comprises the following steps of:

(a) dividing the SDU into a plurality of Protocol Data Units (PDUs) by the transmitter;

(b) calculating an error detection relation equation for each of the PDUs respectively and storing a first checking bit in a header of the PDUs by the transmitter;

(c) transmitting the plurality of PDUs to the receiver by the transmitter;

(d) receiving the plurality of PDUs sequentially and calculating a second checking bit of each of the plurality of PDUs respectively according to the error detection relation equation by the receiver;

(e) comparing the first checking bit in the header of each of the plurality of PDUs with the second checking bit by the receiver; and

(f) transmitting a message to the transmitter to stop the transmitter from transmitting the PDUs to the receiver by the receiver, when the first checking bit does not conform to the second checking bit.

### BRIEF DESCRIPTION OF THE DRAWINGS

FIG. 1 illustrates a centralized wireless communication system of the prior art;

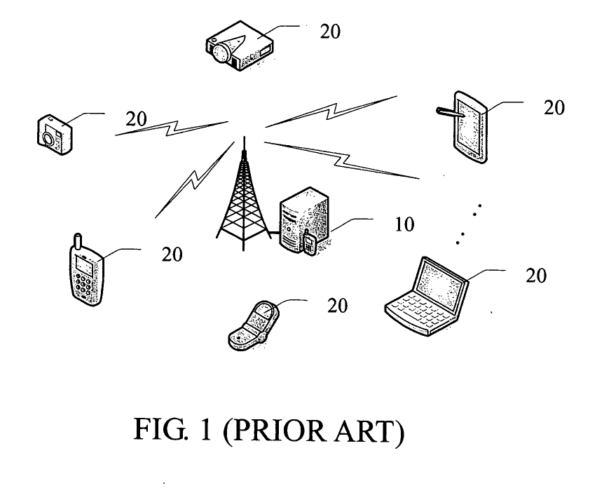

FIG. 2 is an embodiment of a centralized wireless communication system of this invention;

FIG. 3 illustrates the concept of dividing an SDU into a plurality of PDUs in an embodiment of this invention;

FIG. 4 is a flow chart of this invention; and

FIGS. 5a and 5b are diagrams of a dual communication system by this invention.

### DESCRIPTION OF THE PREFERRED EMBODIMENT

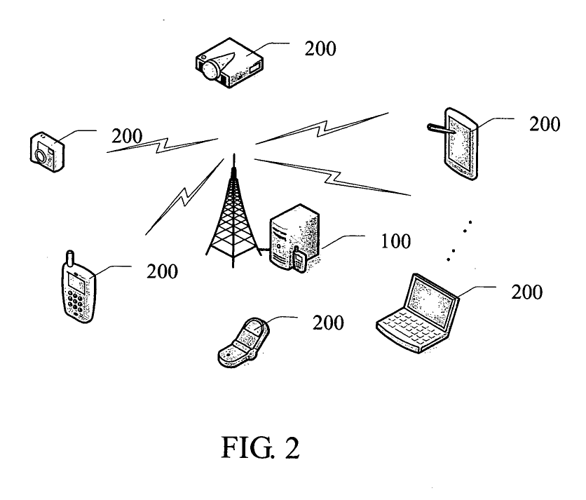

The invention provides a detection method for detecting the correctness of network package transmission. In the following a centralized wireless communication system is adopted as an example to elaborate the features and the advantages of this invention. FIG. 2 shows a wireless communication system utilizing this invention. The wireless communication system comprises a base station 100 and a plurality of subscriber stations 200. The base station 100 can use a wireless channel (not shown) to transmit data downlink to the subscriber stations 200. Similarly, the subscriber stations 200 can use a wireless channel (not shown) to transmit data uplink to the base station 100. In the downlink channel of the base station, the base station transmits data via frames to each subscriber station in the centralized wireless communication system. Each frame comprises a broadcast part and a user data part. By carrying MAP data in the broadcast part, the base station informs each subscriber station about the time period and transmission mode of its corresponding channel.

For the convenience, the one that transmits data actively is called the transmitter in the following. Similarly, the one that receives data passively is called the receiver. In this invention, the base station 100 and the subscriber stations 200 can be a transmitter or a receiver depending on the practical situation.

In order to use channels efficiently, conventional communication protocols adopt the following approach. The transmitter divides an SDU to be transmitted into a plurality of PDUs and transmits the PDUs to the receiver through the channel utilizing time slots of Time Division Multiple Access (TDMA). After the receiver receives all PDUs, it assembles them to get the original SDU to be sent. This invention also adopts the same communication protocol to transmit data. The difference is that this invention does not use conventional packet validation protocol to detect errors for the purpose of preventing the waste of bandwidths.

To be more specifically, the SDU at the transmitter gets an error detection code by the error detection protocol at the upper layer. When the transmitter divides the SDU into a plurality of PDUs, a checking code is derived according to the error detection code. In this invention, the transmitter and the receiver retrieve partial checking bits from the checking code by an agreed method. This is the new error detection criterion of the PDUs.

To be more concrete, the transmitter retrieves the agreed partial checking bits from the checking code and puts them in the header of the PDUs. The transmitter transmits the partial checking bits to the receiver along with the PDUs to let the receiver judge the correctness of each received PDU. In other words, the transmitter and the receiver have an agreed error detection relation equation to determine whether the two checking bits conform to each other. In practical application, the checking bits comprise at least one bit. If the Worldwide Interoperability for Microwave Access (WiMAX) is adopted, PDUs can utilize the three bits in the header of the MAC layer to store the checking bits. The agreed error detection relation equation between the transmitter and the receiver can be the first three bits, the last three bits, or any combination of the bits of the checking code.

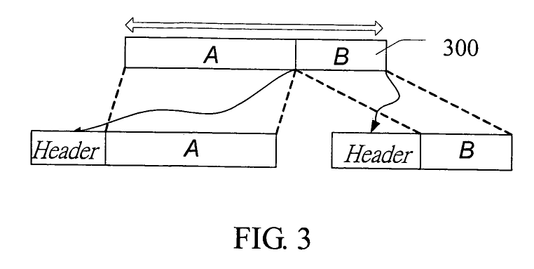

In FIG. 3, a SDU is divided into a PDU A and a PDU B. The two sets of checking bits are filled up in the two headers respectively. To be emphasized, the aforementioned description is only an embodiment of this invention. It is not used to limit the number of partial checking bits and error detection relation equation. People skilled in this field may proceed with a variety of modification according to different communication protocols by the disclosed techniques in this invention.

After the transmitter fills up partial checking bits into the headers of the PDUs sequentially, it transmits the PDUs to the receiver. After the receiver receives a PDU, the checking bits are calculated according to the agreed error detection relation equation at the data link layer. Then, the checking bits are compared with the checking bits in the header of the PDU.

When the checking bits in the header of the PDUs do not conform to the checking bits derived by the calculation of the receiver, it means that the PDU received by the receiver is erroneous and is different from the original transmitted PDU. Consequently, the succeeding untransmitted data will be stopped. This is because even the receiver assembles all PDUs, the resultant data are erroneous. In this invention, in order to improve the channel bandwidth, a message is sent to the transmitter to stop the transmitter from continuously transmitting the untransmitted PDUs to the receiver. Meantime, the base station that controls the allocation of the channel resources re-allocates the original reserved time slots.

Therefore, detection of erroneous SDU will not be delayed to the time that all PDUs are received and assembled like the prior art, which wastes bandwidths. When the checking bits in the header of the PDU conform to the checking bits derived by the calculation of the receiver, it means that the PDU received at the receiver is the same as the PDU transmitted by the transmitter. If the error detection determines that all the received PDUs conform to the transmitted ones, the correctness of the SDU at the upper layer is assured, wherein the SDU is derived by assembling the PDUs.

In simple words, the detection method of this invention detects error across layers. By utilizing partial checking bits, checking the correctness of data at the upper layer (transport layer) can be made at the lower layer (data link layer). The waste of channel bandwidths can be prevented.

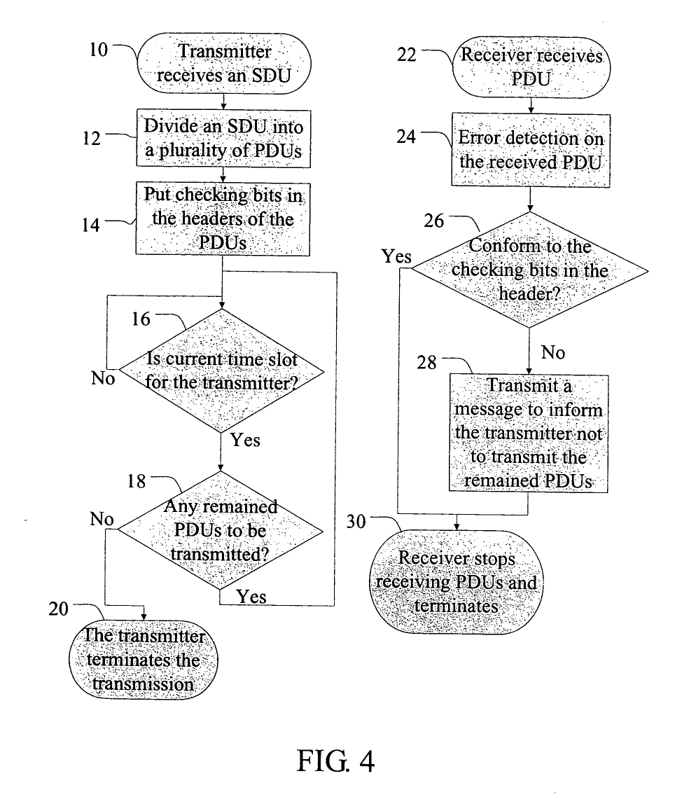

The flow chart of the invention is illustrated in FIG. 4, which shows the transmitter and the receiver. The step 10 to the step 20 show the flow at the transmitter and the step 22 to the step 30 show the flow at the receiver.

More detailed descriptions are made in the following paragraphs. Step 10 shows that the transmitter gets a SDU. Step 12 divides the SDU into a plurality of PDUs. Step 14 puts the checking bits into the header of the PDU. Step 16 checks whether the current time slot is for the transmitter. If not, goes back to step 16. If is, goes to step 18 to see if there exist remained PDUs to be transmitted. If yes, goes back to step 16; otherwise, goes to step 20, which shows the termination of the transmission.

Furthermore, step 22 shows the receiver receives the PDU. Step 24 calculates the error detection for the received PDU. Step 26 checks whether the derived checking bits conform to checking bits in the header of the PDU. If not, goes to step 28; otherwise, goes to step 30. In step 28, the receiver sends a message to inform the transmitter not to transmit the remained PDUs in next frame and then goes to step 30. Step 30 the receiver stops receiving PDUs and terminates.

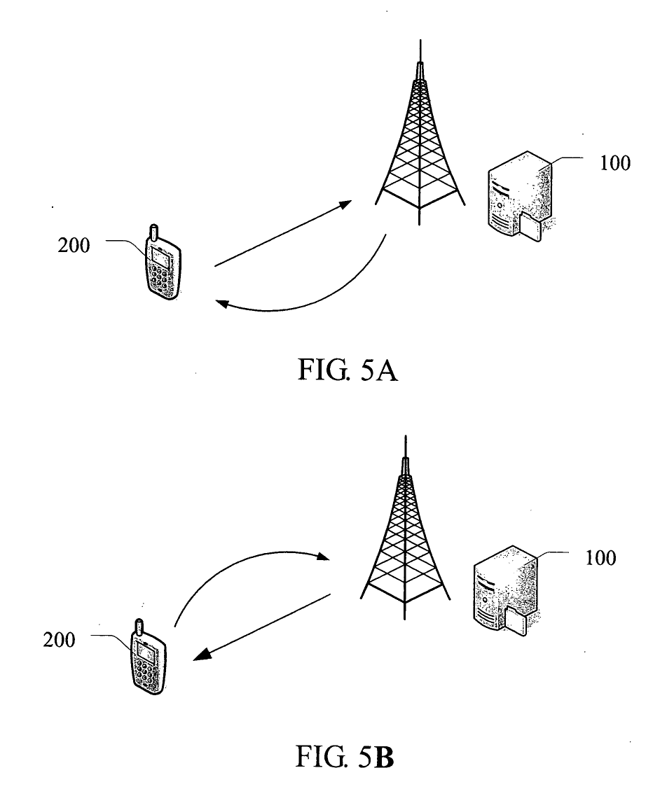

FIG. 5 shows that the disclosed method of this invention can be applied to the base station 100 and the subscriber station 200 for dual communication. To be more concrete, the subscriber station 200 and the base station 100 in FIG. 5A are the transmitter and the receiver, respectively. Under this condition, the subscriber station 200 transmits a plurality of PDUs to the base station 100. If the base station 100 detects an erroneous PDU by the aforementioned disclosed method, the base station 100 reallocates the reserved channel bandwidths for other users. The base station 100 then transmits a message to the subscriber station 200 to terminate the transmission of the remaining PDUs and discards the untransmitted PDUs. Retransmission of complete and correct PDUs is the responsibility of the upper layer and is not covered by this invention.

In FIG. 5B, the base station 100 is the transmitter and the subscriber station 200 is the receiver. Under this condition, the base station 100 transmits a plurality of PDUs to the subscriber station 200. If the subscriber station 200 detects an erroneous PDU by the aforementioned disclosed method, the subscriber station 200 sends a message to inform the base station 100 to stop transmitting remained PDUs. The base station 100 reallocates the reserved channel bandwidths for other users. It has to be mentioned that the base station not only terminates the transmission of succeeding PDUs but also discards the untransmitted PDUs. Retransmission of complete and correct PDUs is the responsibility of the upper layer and is not covered by this invention.

The aforementioned method may be executed by using a computer program product which stores a computer program. The computer program comprises code to execute the above-mentioned steps of the method. The computer program product can be a floppy disk, a hard disk, an optical disc, a flash disk, a tape, an internet accessible database or any storage medium with a similar functionality of storage which is easily thought by people skilled in the field.

The above embodiments are used as the examples of the subject invention and used to explain the technical characters of the subject invention and are not used to limit the range of the subject invention. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A detection method for detecting the correctness of network package transmission, the method being utilized in a centralized wireless communication system, the wireless communication system comprising at least a transmitter and a receiver, the transmitter transmitting data to the receiver through a channel, the data comprising a Service Data Unit (SDU), the detection method comprising the following steps of:
(a) dividing the SDU into a plurality of Protocol Data Units (PDUs) by the transmitter;
(b) calculating an error detection relation equation for each of the PDUs respectively and storing a first checking bit in a header of the PDUs by the transmitter;
(c) transmitting the PDUs to the receiver by the transmitter;
(d) receiving the PDUs sequentially and calculating a second checking bit of each of the PDUs respectively according to the error detection relation equation by the receiver;
(e) comparing the first checking bit in the header of each of the PDUs with the second checking bit by the receiver; and
(f) transmitting a message to the transmitter to stop the transmitter from transmitting the PDUs to the receiver by the receiver, when the first checking bit does not conform to the second checking bit.

2. The detection method of claim 1, wherein the transmitter transmits the data to the receiver via the time slot of the time division multiple access (TDMA).

3. The detection method of claim 1, wherein the SDU further comprises an error detection code, the transmitter generating the first checking bit after using the error detection code to calculate the error detection relation equation.

4. The detection method of claim 3, wherein the error detection code is calculated according to the error detection protocol in the transport protocol.

5. The detection method of claim 1, wherein the first checking bit and the second checking bit comprise at least one bit.

6. The detection method of claim 5, wherein the first checking bit and the second checking bit comprise three bits in the IEEE 802.16 Worldwide Interoperability for Microwave Access (WiMax).

7. The detection method of claim 1, wherein the step (f) further comprises receiving the PDUs continuously when the first checking bit confirms to the second checking bit by the receiver.

8. The detection method of claim 1, wherein the receiver is a Subscriber Station (SS) when the transmitter is a Base Station (BS).

9. The detection method of claim 8, wherein the step (f) further comprises:
(g) reallocating bandwidth of the channel by the BS after the BS stops transmitting the PDUs to the SS.

10. The detection method of claim 1, wherein the receiver is a BS when the transmitter is an SS.

11. The detection method of claim 10, wherein the step (f) further comprises:
(g) reallocating bandwidth of the channel by the BS when the first checking bit does not conform to the second checking bit.

12. A computer program product for storing a computer program to execute a detection method for detecting the correctness of network package transmission, the method being utilized in a centralized wireless communication system, the wireless communication system comprising at least a transmitter and a receiver, the transmitter transmitting data to the receiver through a channel, the data comprising a Service Data Unit SDU, the detection method comprising the following steps of:
(a) dividing the SDU into a plurality of Protocol Data Units (PDUs) by the transmitter;
(b) calculating an error detection relation equation for each of the PDUs respectively and storing a first checking bit in a header of the PDUs by the transmitter;
(c) transmitting the plurality of PDU to the receiver by the transmitter;
(d) receiving the plurality of PDU sequentially and calculating a second checking bit of each of the plurality of PDUs respectively according to the error detection relation equation by the receiver;
(e) comparing the first checking bit in the header of each of the plurality of PDUs with the second checking bit by the receiver; and
(f) transmitting a message to the transmitter to stop the transmitter from transmitting the PDUs to the receiver by the receiver, when the first checking bit does not conform to the second checking bit.

13. The computer program product of claim 12, wherein the transmitter transmits the data to the receiver via time slots of Time Division Multiple Access (TDMA).

14. The computer program product of claim 12, wherein the SDU further comprises an error detection code, the transmitter generating the first checking bit after using the error detection code to calculate the error detection relation equation.

15. The computer program product of claim 14, wherein the error detection code is calculated according to the error detection protocol in the transport protocol.

16. The computer program product of claim 12, wherein the first checking bit and the second checking bit comprise at least one bit.

17. The computer program product of claim 16, wherein the first checking bit and the second checking bit comprise three bits in the IEEE 802.16 Worldwide Interoperability for Microwave Access (WiMax).

18. The computer program product of claim 12, wherein the step (f) further comprises receiving the PDUs continuously when the first checking bit conform to the second checking bit by the receiver.

19. The computer program product of claim 12, wherein the receiver is a Subscriber Station (SS) when the transmitter is a Base Station (BS).

20. The computer program product of claim 19, wherein the step (f) further comprises:
(g) reallocating bandwidth of the channel by the BS after the BS stops transmitting the PDUs to the SS.

21. The computer program product of claim 12, wherein the receiver is a BS when the transmitter is an SS.

22. The computer program product of claim 21, wherein the step (f) further comprises:
(g) reallocating bandwidth of the channel by the BS when the first checking bit does not conform to the second checking bit.
